(19) United States
(12) Patent Application Publication
(10) Pub. No.: US 2021/0337116 A1
(43) Pub. Date: Oct. 28, 2021

(54) Light Spectrum Application and Method

(71) Applicant: Steven Green, Oakland, CA (US)

(72) Inventor: Steven Green, Oakland, CA (US)

(21) Appl. No.: 16/935,836

(22) Filed: Jul. 22, 2020

Related U.S. Application Data
(60) Provisional application No. 63/015,950, filed on Apr. 27, 2020.

(51) Int. Cl. H04N 5/232; H04N 5/91; G06F 3/14

(52) U.S. Cl. CPC H04N 5/23229; H04N 5/23216; G06K 9/00087; G06F 3/14; H04N 5/91

(57) ABSTRACT

A non-transitory, computer-readable medium comprising software instructions that, when executed by at least one processor of a camera-equipped mobile electronic device, causes the at least one processor to upload a digital image and convert the uploaded image to an image viewable in a different light spectrum. The converted image viewable in a different light spectrum is then displayed on the electronic device. A system and a method for converting and viewing a digital image in a plurality of light spectrums are also provided. The system and method comprise using a mobile electronic device with a light spectrum converting component to convert a digital image into an image displayable in a different light spectrum other than the visible light spectrum.

### CROSS-REFERENCE TO RELATED APPLICATION

The present application claims priority to, and the benefit of, U.S. Provisional Application No. 63/015,950, which was filed on Apr. 27, 2020 and is incorporated herein by reference in its entirety.

### BACKGROUND

The present invention generally relates to a way to view different light spectrums with a smartphone, and more specifically to a light spectrum application for use with a smartphone. Accordingly, the present specification makes specific reference thereto. However, it is to be appreciated that aspects of the present invention are also equally amenable to other like applications, devices and methods of manufacture.

Viewing different light spectrums other than the visible light spectrum can be nearly impossible without specific tools. When using a smartphone to view the different spectrums, attachments or other add on devices are necessary. However, these attachments and devices can be difficult to operate effectively. Additionally, transitioning from one device to another can take a considerable amount of time.

Light spectrum is the range of wavelengths produced by a light source. When discussing light spectrum, the term ‘light’ refers to the visible wavelengths of the electromagnetic spectrum that humans can see from approximately 380-740 nanometers (nm). Ultraviolet (approximately 10 nm-400 nm), far-red (approximately 700-850 nm), and infra-red (approximately 700 nm-1100 nm) wavelengths are often referred to as radiation.

Most digital cameras, including smart phone cameras, are designed to capture an image of what people can see. Hence a good digital camera would only detect electromagnetic (EM) radiation in the visible light spectrum (between approximately 400 nm and 700 nm). A charge-coupled device (CCD) is a light-sensitive integrated circuit that stores and displays the data for an image in such a way that each pixel (picture element) in the image is converted into an electrical charge the intensity of which is related to a color in the color spectrum. The charged couple devices used within these cameras are typically manufactured to pick up EM radiation approximately between 300 nm and 1100 nm. This means they are capable of detecting infrared light in addition to visible light.

To improve digital image quality, camera manufacturers typically add internal films and filters to block out the infrared light and ensure only visible light reaches the CCD. If the infrared radiation was recorded by the camera and appeared in the digital photos, the digital photos would not be an accurate representation of what humans typically see. Therefore, the images are displayed in the visible spectrum, not in the infrared spectrum. Additionally, since the cameras are sensitive to the visible spectrum, the visible spectrum registers much brighter on the CCD essentially drowning out the infrared image. A separate external physical filter is needed to attach to the camera to turn it into a makeshift spectrometer that will block out the visible spectrum thereby allowing a view of the image in another spectrum, such as the infrared spectrum.

Fluorescence spectroscopy is a type of electromagnetic spectroscopy that analyzes fluorescence from a sample. It involves using a beam of light, usually ultraviolet light, that excites the electrons in molecules of certain compounds and causes them to emit light; typically, but not necessarily, visible light. A complementary technique is absorption spectroscopy. In the special case of single molecule fluorescence spectroscopy, intensity fluctuations from the emitted light are measured from either single fluorophores, or pairs of fluorophores.

Phosphorescence is a type of photoluminescence related to fluorescence. Unlike fluorescence, a phosphorescent material does not immediately re-emit the radiation it absorbs. The slower time scales of the re-emission are associated with “forbidden” energy state transitions in quantum mechanics. As these transitions occur very slowly in certain materials, absorbed radiation is re-emitted at a lower intensity for up to several hours after the original excitation.

Most black lights work using a filter or coating over the bulb that filters out most of the visible light and produces mostly long-wave ultraviolet (UV) light. These filters create a dim violet glow, while coated bulbs product blue color. Fluorescence, the radiating glow emitted by certain substances when exposed to ultraviolet light, is visible under a black light. While no smartphone is technically capable of emitting UV light, the effect may be mimicked using the smartphone's light-emitting diode (LED) flash in conjunction with other tools. This is useful to highlight fluids, fingerprints, and contaminated surfaces that contain fluorescence or fluorescent proteins.

In this manner, the improved light spectrum viewing platform of the present invention accomplishes all of the forgoing objectives, thereby providing an easy solution for users to view images in a plurality of different light spectrums. A primary feature of the present invention is the ability to view images in different light spectrums using a smartphone without the need for external attachments. Finally, the present invention is capable of providing digital images viewable on the smartphone display in the phosphorescent spectrum.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a non-transitory computer-readable medium comprising a set of software instructions. When analyzed by at least one processor, the software instructions cause the processor to upload a digital image. The processor then converts the uploaded image to an image viewable in a different spectrum. The at least one processor may be a processing system of a camera-equipped mobile electronic device, such as a smart phone. Then the converted image is displayed on the smartphone. The different spectrum is one other than the visible light spectrum, such as, but not limited to an infrared spectrum, an ultraviolet spectrum, or a phosphorescent spectrum. The processor may further convert the image to another of the different light spectrums.

An additional embodiment of the present invention comprises a system for viewing an image in a plurality of spectrums. The system comprises a camera-equipped mobile electronic device, such as a smartphone, having a non-transitory computer-readable medium comprising a set of software instructions. The system further comprises a spectrum converting component. The spectrum converting component is configured to upload a digital image or video taken by a camera of the smartphone. The spectrum converting component then converts the digital image or video to an image or video viewable in a selected spectrum other than the visible light spectrum. The selected spectrum is one other than the visible light spectrum, such as, but not limited to an infrared spectrum, an ultraviolet spectrum, or a phosphorescent spectrum. Then the image or video is displayed in the selected light spectrum on the smartphone.

An additional embodiment of the present invention comprises a method of viewing an image in a plurality of spectrums. The method comprises the steps of selecting a first spectrum other than the visible light spectrum and obtaining a digital image on a camera-equipped mobile electronic device, such as a smartphone. A spectrum converting component then converts the digital image into an image viewable in the selected spectrum. Then the image is displayed on the smartphone in the selected spectrum. The selected spectrum is one other than the visible light spectrum, such as, but not limited to an infrared spectrum, an ultraviolet spectrum, or a phosphorescent spectrum. A different spectrum may then be selected and the spectrum converting component then converts the digital image to the different spectrum for display. The converted image may then be saved or compared to a plurality of images in a database.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic diagram of a computer environment for practicing aspects of the present technology in accordance with the disclosed architecture.

FIG. 2 illustrates a perspective view of a camera-equipped mobile electronic device of the present invention displaying a spectrum converting application in accordance with the disclosed architecture.

FIG. 3 illustrates a perspective view of a camera-equipped mobile electronic device of the present invention displaying a plurality of options for converting an image to a different spectrum in accordance with the disclosed architecture.

FIG. 4 illustrates a perspective view of a camera-equipped mobile electronic device of the present invention displaying an image converted into a selected spectrum in accordance with the disclosed architecture.

FIG. 5 illustrates a perspective view of a camera-equipped mobile electronic device of the present invention displaying an image converted into a different spectrum in accordance with the disclosed architecture.

FIG. 6 illustrates a perspective view of a camera-equipped mobile electronic device of the present invention comparing an image converted into the different spectrum to a database of images in accordance with the disclosed architecture.

FIG. 7 illustrates a flowchart of a method of viewing an image in a plurality of spectrums of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a smartphone application designed to view different light spectrums with a single device. The invention allows users to view infrared (IR), ultraviolet (UV), and phosphorescent light spectrums by using the smartphone camera to view the affected area. The invention also allows users to shuffle through different light spectrum views directly of the application rather than using an attachment. A computer algorithm is configured to cycle through the spectrums and adjust the camera lens on the smartphone. The invention offers a way to obtain greater ease for transitioning from one light spectrum to another.

The software application is capable of displaying the various light spectrums at the push of a button. The application uses the smartphone cameras to enable the user to see in any light spectrum not typically visible to the human eye, including IR, UV, and phosphorescence spectrums. Users can install and activate the application, selecting a light spectrum to adjust the camera. The system may also have the ability to connect to databases for law enforcement or other agencies to view fingerprints or other identifying images. The UV portion of the system can provide fingerprints to the databases for comparison to find a match. Other uses and applications may vary, allowing individuals to utilize the different light spectrums as needed.

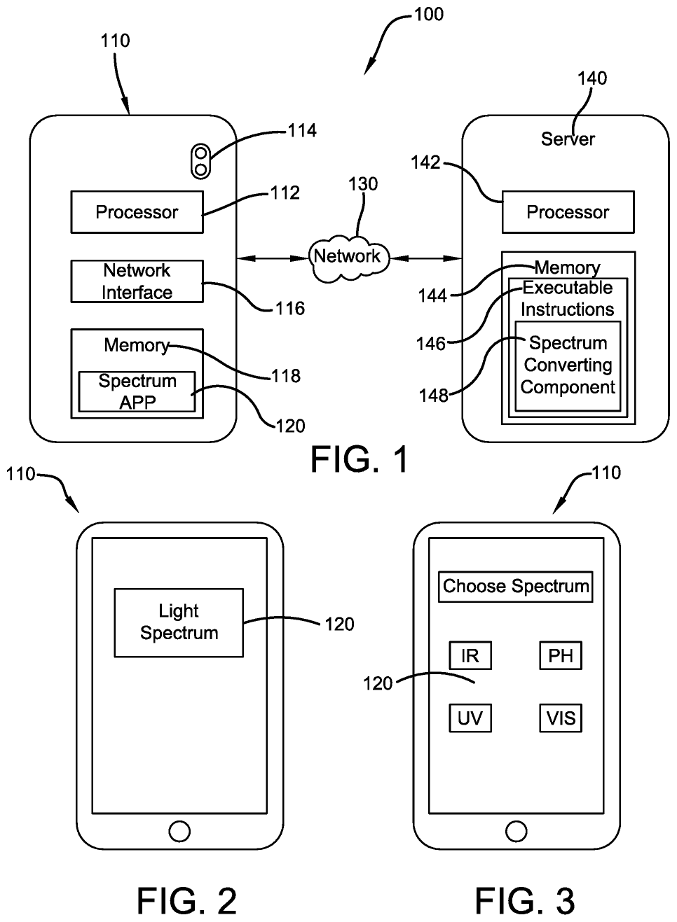

Referring initially to the drawings, FIG. 1 illustrates a system 100 for viewing an image 10 in a plurality of spectrums. The system 100 comprises a camera-equipped mobile electronic device 110. The camera-equipped mobile electronic device 110 is a user interface such as, but not limited to, a mobile phone, a smart phone, a tablet, an iPad, or the like. The camera-equipped mobile electronic device 110 is equipped with at least one processor 112, at least one camera 114 or similar image capturing device, a network interface 116, and a memory 118. The at least one processor 112 is a processing system of the mobile electronic device 110 and is configured to execute instructions that are stored in the memory 118. The memory 118 comprises a non-transitory computer-readable medium comprising a set of software instructions 120 that stores a spectrum converting component in the form of a spectrum converting App as illustrated in FIG. 2. The set of software instructions 120 allows the camera-equipped mobile electronic device 110 to perform methods of the present technology when executed by the at least one processor 112.

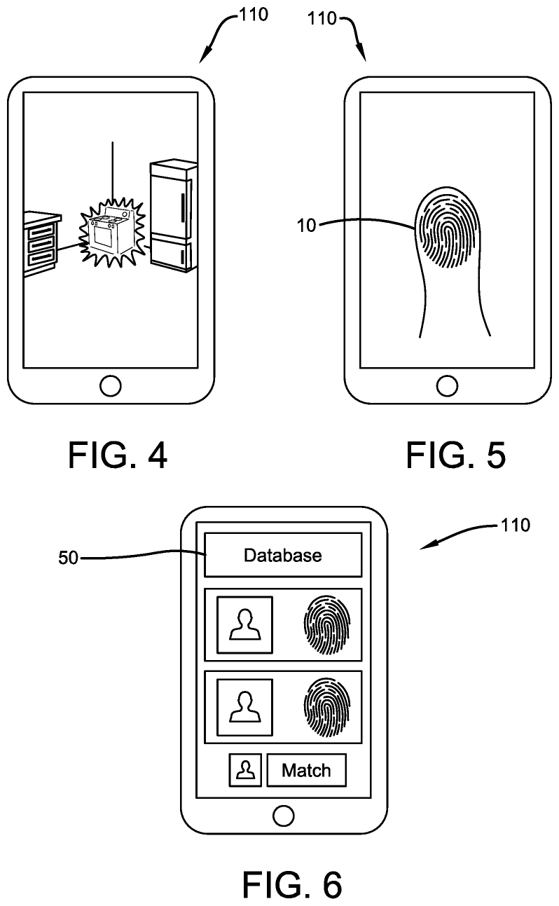

The at least one processor 112 causes the non-transitory computer-readable medium comprising the set of software instructions 120 to upload the digital image 10 viewable initially in a visible light spectrum, typically in the approximately 400-700 nm wavelength range. As illustrated in FIG. 3, the uses selects a different spectrum from a plurality of different spectrums including, but not limited to, the UV spectrum of between the approximately 10-400 nm wavelength range, the IR spectrum of between the approximately 700-1100 nm wavelength range, or the phosphorescent spectrum. Once a different spectrum is selected, the set of software instructions 120 converts the uploaded digital image 10 into an image viewable in the different spectrum. Then the converted image is displayed in the different light spectrum on the camera-equipped mobile electronic device 110 as illustrated in FIGS. 4 and 5. The digital image 10 may be a digital photograph or a digital video.

Returning to FIG. 1, the system 100 may further comprise a server 140 comprising a server processor 142 and a server memory 144. The server memory 144 comprises a set of executable software instructions 146 storing a spectrum converting component 148. A network 130 connects the camera-equipped mobile electronic device 110 to the server 140 via the network interface 116. The network 130 may be any of a number of private or public communications mechanisms such as the Internet, a local intranet, a Personal Area Network, a Local Area Network, a Wide Area Network, a Virtual Private Network, or the like. When the camera-equipped mobile electronic device 110 is connected to the server 140 via the network 130, the set of executable software instructions 146 allows the server 140 to perform methods of the present technology when executed by the server processor 142.

The spectrum converting component 148 is configured to receive the uploaded image 10 in the visible light spectrum and convert the uploaded digital image 10 into an image viewable in a selected spectrum. The selected spectrum may be the UV spectrum, the IR spectrum, or the phosphorescent spectrum. Then the converted image is displayed in the selected light spectrum on the camera-equipped mobile electronic device 110 as illustrated in FIGS. 4 and 5. The digital image 10 may be a digital photograph or a digital video.

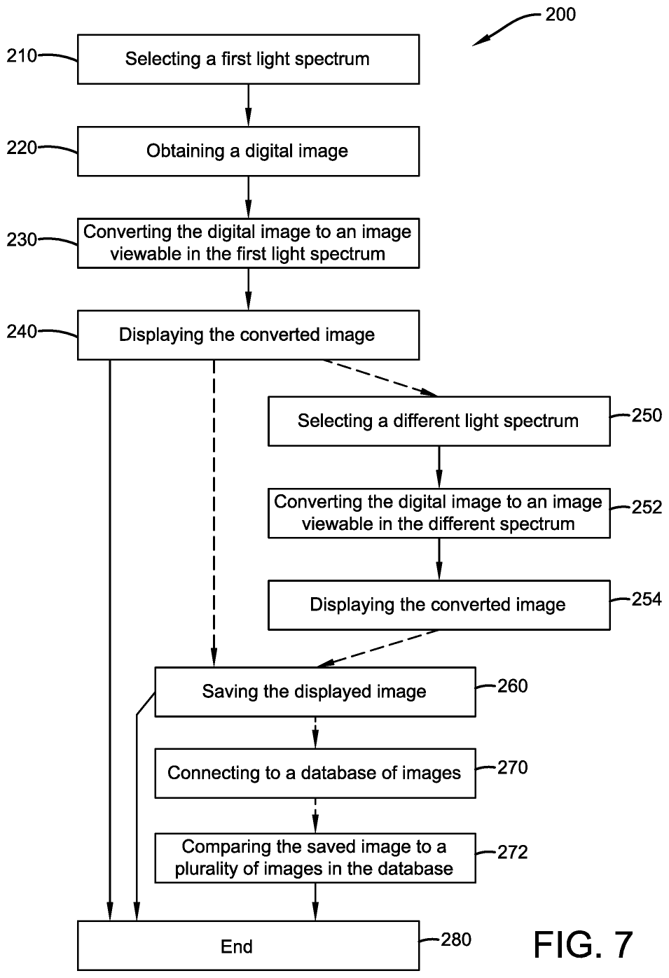

In an additional embodiment, a method 200 of viewing an image 10, such as a digital picture or video, in a plurality of spectrums is illustrated in FIG. 7. The method 200 begins by using a set of software instructions 120 loaded on a camera-equipped mobile electronic device 110 to select a first spectrum at 210. The first spectrum may be the UV spectrum, the IR spectrum, or the phosphorescent spectrum. Next, at 220, the user obtains the digital image 10 using the camera 114 of the camera-equipped mobile electronic device 110. Then, the set of software instructions 120 is used to convert the image 10 to an image viewable in the selected first spectrum at 230. The converted image is then displayed of the camera-equipped mobile electronic device 110 in the selected first spectrum. The converted image may then be saved at 260.

At 250, the user may select a different spectrum from the selected first spectrum. Next, at 252, the set of software instructions 120 is used to convert the image 10 to an image viewable in the different spectrum. The converted image is then displayed of the camera-equipped mobile electronic device 110 in the different spectrum. The converted image may then be saved at 260 into a memory 118 of the camera-equipped mobile electronic device 110.

If the selected first spectrum or the different spectrum is the phosphorescent spectrum, at 270, the set of software instructions 120 may connect to an external data base 50 as illustrated in FIG. 6. For example, if the image 10 is a fingerprint converted to the phosphorescent spectrum, the saved fingerprint image may be compared to a plurality of fingerprint images stored in the external database 50 for a match. The UV spectrum may be used to convert the image to the phosphorescent spectrum. When an electron moves from a higher to lower energy level, light is produced. For fluorescence, a frequency of light higher than visible must be used. When the UV light is shined on some materials or surfaces, it produces light of lower frequency which will show up in the phosphorescent spectrum. The method then ends at 280.

It is contemplated that the system 100 and method 200 constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A non-transitory, computer-readable medium comprising software instructions that, when executed by at least one processor, causes the at least one processor to:
upload a digital image viewable in a visible light spectrum;
convert the uploaded image to an image viewable in a different spectrum; and
display the converted image in the different spectrum.

2. The non-transitory, computer-readable medium according to claim 1, wherein the at least one processor is a processing system of a camera-equipped mobile electronic device.

3. The non-transitory, computer-readable medium according to claim 1, wherein the different spectrum is an infrared spectrum.

4. The non-transitory, computer-readable medium according to claim 1, wherein the different spectrum is an ultraviolet spectrum.

5. The non-transitory, computer-readable medium according to claim 1, wherein the different spectrum is a phosphorescence spectrum.

6. The non-transitory, computer-readable medium according to claim 1 further comprising uploading a digital video viewable in the visible light spectrum; converting the uploaded video to a video viewable in the different spectrum; and displaying the converted video in the different spectrum.

7. The non-transitory, computer-readable medium according to claim 6, wherein the different spectrum is an infrared spectrum, an ultraviolet spectrum, or a phosphorescence spectrum.

8. A system for viewing an image in a plurality of spectrums, the system comprising:
a camera-equipped mobile electronic device having a non-transitory, computer-readable medium comprising software instructions; and
a spectrum converting component configured to:
upload a digital image taken by a camera of the camera-equipped mobile electronic device;
convert the digital image to an image viewable in a selected spectrum; and
display the converted image in the selected spectrum on the camera-equipped mobile electronic device.

9. The system of claim 8, wherein the selected spectrum is an infrared spectrum.

10. The system of claim 8, wherein the selected spectrum is an ultraviolet spectrum.

11. The system of claim 8, wherein the selected spectrum is a phosphorescence spectrum.

12. The system of claim 8, wherein the digital image is a video.

13. A method of viewing an image in a plurality of spectrums, the method comprising the steps of:
selecting a first spectrum;
obtaining a digital image with a camera-equipped mobile electronic device;
converting the digital image to an image viewable in the selected spectrum; and
displaying the converted image in the selected spectrum on the camera-equipped mobile electronic device.

14. The method of claim 13, wherein the first spectrum is an infrared spectrum.

15. The method of claim 13, wherein the first spectrum is an ultraviolet spectrum.

16. The method of claim 13, wherein the first spectrum is a phosphorescence spectrum.

17. The method of claim 13, wherein the image is a video.

18. The method of claim 13 further comprising the steps of:
selecting a different spectrum other than the selected spectrum;
converting the digital image to an image viewable in the different spectrum; and
displaying the converted image in the different spectrum on the camera-equipped mobile electronic device.

19. The method of claim 13 further comprising the step of comparing the converted image in the selected spectrum to a plurality of images in a database.

20. The method of claim 13 further comprising the step of saving the converted image in the selected spectrum to a memory of the camera-equipped mobile electronic device.
